(19) United States
(12) Patent Application Publication
(10) Pub. No.: US 2006/0089775 A1
(43) Pub. Date: Apr. 27, 2006

(54) Method and apparatus for adaptive control of power-on downshifts in an automatic transmission

(76) Inventors: Matthew D. Whitton, Howell, MI (US); Robert L. Williams, Holly, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/972,067

(22) Filed: Oct. 22, 2004

(51) Int. Cl. G06F 19/00

(52) U.S. Cl. 701/51; 701/55

(57) ABSTRACT

The present invention provides a method and apparatus for mathematically calculating an initial value of an adaptive parameter and thereafter adaptively controlling a power-on downshift in an automatic transmission wherein a transmission aberration during a shift is diagnosed and corrected during subsequent power-on downshifts. The invention is carried out by monitoring transmission characteristics including input speed, output speed and shift duration during a power-on downshift, and identifying departures from acceptable patterns. Each type of departure calls for a particular remedy, and a suitable adjustment is calculated based on the times and/or the commanded pressures at certain times, the adjustment being implemented by changing one or more initial conditions for the next shift of the same type. The adjustments may have to be large to make a full or significant partial correction at the next shift. Conversely small increments may be necessary to avoid over-correction.

### TECHNICAL FIELD

The present invention relates to a method and apparatus for improving power-on downshifts of an automatic transmission.

### BACKGROUND OF THE INVENTION

Generally, a motor vehicle automatic transmission includes a number of gear elements coupling its input and output shafts, and a related number of torque establishing devices such as clutches and brakes that are selectively engageable to activate certain gear elements for establishing a desired speed ratio between the input and output shafts. As used herein, the terms “clutches” and “torque transmitting devices” will be used to refer to brakes as well as clutches.

The transmission input shaft is connected to the vehicle engine through a fluid coupling such as a torque converter, and the output shaft is connected directly to the vehicle wheels. Shifting from one forward speed ratio to another is performed in response to engine throttle and vehicle speed, and generally involves releasing or disengaging the clutch (off-going) associated with the current speed ratio and applying or engaging the clutch (on-coming) associated with the desired speed ratio.

The speed ratio is defined as the transmission input speed or turbine speed divided by the output speed. Thus, a low gear range has a high speed ratio and a higher gear range has a lower speed ratio. To perform a downshift, a shift is made from a low speed ratio to a high speed ratio. In the type of transmission involved in this invention, the downshift is accomplished by disengaging a clutch associated with the lower speed ratio and engaging a clutch associated with the higher speed ratio, to thereby reconfigure the gear set to operate at the higher speed ratio. Shifts performed in the above manner are termed clutch-to-clutch shifts and require precise timing in order to achieve high quality shifting.

The quality of shift depends on the cooperative operation of several functions, such as pressure changes within on-coming and off-going clutch apply chambers and the timing of control events. Moreover, manufacturing tolerances in each transmission, changes due to wear, variations in oil quality and temperature, etc., lead to shift quality degradation.

### SUMMARY OF THE INVENTION

The invention provides a method and apparatus for calculating optimal values for off-going clutch torque and transmission input torque, and thereafter adaptively controlling a power-on downshift in an automatic transmission wherein a transmission aberration during a shift is diagnosed and corrected during subsequent power-on downshifts.

The method of the present invention is capable of making both large and small corrections.

The method of the invention is carried out by mathematically calculating optimal values for off-going clutch torque and transmission input torque through the shift event. The method of the invention also monitors transmission characteristics including input speed, output speed, and shift duration during a power-on downshift, and identifies departures from acceptable patterns. Each type of departure calls for a particular remedy, and a suitable adjustment is calculated and applied by changing certain parameters in the shift control to alter one or more conditions for the next shift of the same type. The adjustments may have to be large to make a full or significant partial correction at the next shift. Conversely, small increments may be necessary to avoid over-correction.

The above objects, features and advantages, and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic illustration of an automatic transmission;

FIG. 1a is a schematic illustration of a valve of FIG. 1;

FIG. 2a is a block diagram illustrating a method of calculating off-going clutch pressure during the inertia phase of a ratio change;

FIG. 2b is a block diagram illustrating a method of calculating input torque during the torque phase of a ratio change;

FIG. 3a is a graphical depiction of turbine acceleration vs. time during an optimal power-on downshift;

FIG. 3b is a graphical depiction of turbine speed vs. time during an optimal power-on downshift;

FIG. 4 is a schematic illustration of an automatic transmission;

FIG. 5a is a graphical depiction of turbine speed vs. time during an optimal power-on downshift;

FIG. 5b is a graphical depiction of the off-going clutch pressure vs. time during the optimal power-on downshift of FIG. 5a;

FIG. 5c is a graphical depiction of the on-coming clutch pressure vs. time during the optimal power-on downshift of FIG. 5a;

FIG. 6a is a graphical depiction of turbine speed during the shift aberrations “slip early” and “slip late”;

FIG. 6b is a graphical depiction of turbine speed during the shift aberration “flare”;

FIG. 6c is a graphical depiction of turbine speed during the shift aberrations “short shift,” “long shift,” “closed loop increase,” and “closed loop decrease”;

FIG. 6d is a graphical depiction of turbine speed during the shift aberration “underlap turbine float”;

FIG. 7 is a block diagram illustrating a method of adjusting the off-going pressure adaptive parameter of the present invention; and

FIG. 8 is a block diagram illustrating a method of adjusting the on-coming volume adaptive parameter of the present invention.

### DESCRIPTION OF THE PREFERRED EMBODIMENT

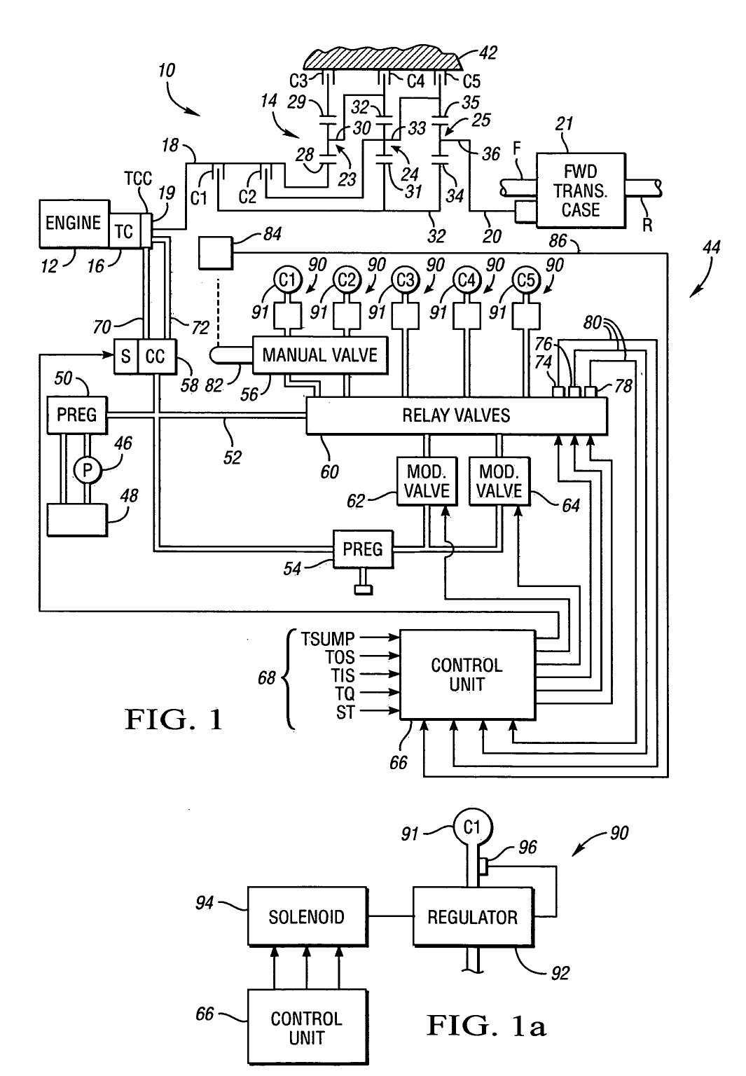

The control of this invention is described in the context of a multi-ratio power transmission having a planetary gear set of the type described in the U.S. Pat. No. 4,070,927 to Polak, and having an electro-hydraulic control of the type described in U.S. Pat. No. 5,601,506 to Long et al, both of which are hereby incorporated by reference in their entireties. Accordingly, the gear set and control elements shown in FIG. 1 hereof have been greatly simplified, it being understood that further information regarding the fluid pressure routings and so on may be found in the aforementioned patents.

Referring to FIG. 1, the reference numeral 10 generally designates a vehicle power train including engine 12, transmission 14, and a torque converter 16 providing a fluid coupling between engine 12 and transmission input shaft 18. It should be appreciated that while the invention will be described as being used with a conventional engine 12, alternate power sources such as an electric motor or hybrid electric/gas motor may be implemented as well.

A torque converter clutch 19 is selectively engaged under certain conditions to provide a mechanical coupling between engine 12 and transmission input shaft 18. The transmission output shaft 20 is coupled to the driving wheels of the vehicle in one of several conventional ways. The illustrated embodiment depicts a four-wheel-drive (FWD) application in which the output shaft 20 is connected to a transfer case 21 that is also coupled to a rear drive shaft R and a front drive shaft F. Typically, the transfer case 21 is manually shiftable to selectively establish one of several drive conditions, including various combinations of two-wheel-drive and four-wheel drive, and high or low speed range, with a neutral condition occurring intermediate the two and four wheel drive conditions.

The transmission 14 has three inter-connected planetary gear sets, designated generally by the reference numerals 23, 24 and 25. The planetary gear set 23 includes a sun gear member 28, a ring gear member 29, and a planet carrier assembly 30. The planet carrier assembly 30 includes a plurality of pinion gears rotatably mounted on a carrier member and disposed in meshing relationship with both the sun gear member 28 and the ring gear member 29. The planetary gear set 24 includes a sun gear member 31, a ring gear member 32, and a planet carrier assembly 33. The planet carrier assembly 33 includes a plurality of pinion gears rotatably mounted on a carrier member and disposed in meshing relationship with both the sun gear member 31 and the ring gear member 32. The planetary gear set 25 includes a sun gear member 34, a ring gear member 35, and a planet carrier assembly 36. The planet carrier assembly 36 includes a plurality of pinion gears rotatably mounted on a carrier member and disposed in meshing relationship with both the sun gear member 34 and the ring gear member 35.

The input shaft 18 continuously drives the sun gear 28 of gear set 23, selectively drives the sun gears 31, 34 of gear sets 24, 25 via clutch C1, and selectively drives the carrier 33 of gear set 24 via clutch C2. The ring gears 29, 32, 35 of gear sets 23, 24, 25 are selectively connected to ground 42 via clutches (i.e., brakes) C3, C4 and C5, respectively.

The state of the clutches C1-C5 (i.e., engaged or disengaged) can be controlled to provide six forward speed ratios (1, 2, 3, 4, 5, 6), a reverse speed ratio (R) or a neutral condition (N). For example, the first forward speed ratio is achieved by engaging clutches C1 and C5. Downshifting from one forward speed ratio to another is generally achieved by disengaging one clutch (referred to as the off-going clutch) while engaging another clutch (referred to as the on-coming clutch). For example, the transmission 14 is downshifted from second to first by disengaging clutch C4 while engaging clutch C5.

The torque converter clutch 19 and the transmission clutches C1-C5 are controlled by an electro-hydraulic control system, generally designated by reference numeral 44. The hydraulic portions of the control system 44 include a pump 46 which draws hydraulic fluid from a reservoir 48, a pressure regulator 50 which returns a portion of the pump output to reservoir 48 to develop a regulated pressure in line 52, a secondary pressure regulator valve 54, a manual valve 56 manipulated by the driver of the vehicle, and a number of solenoid-operated fluid control valves 58, 60, 62 and 64.

The electronic portion of the electro-hydraulic control system 44 is primarily embodied in the transmission control unit 66, or controller, which is microprocessor-based and conventional in architecture. The transmission control unit 66 controls the solenoid-operated fluid control valves 58-64 based on a number of inputs 68 to achieve a desired transmission speed ratio. Such inputs include, for example, signals representing the transmission input speed TIS, a driver torque command TQ, the transmission output speed TOS, and the hydraulic fluid temperature Tsump. Sensors for developing such signals may be conventional in nature, and have been omitted for simplicity.

The control lever 82 of manual valve 56 is coupled to a sensor and display module 84 that produces a diagnostic signal on line 86 based on the control lever position; such signal is conventionally referred to as a PRNDL signal, since it indicates which of the transmission ranges (P, R, N, D or L) has been selected by the vehicle driver. Finally, fluid control valves 60 are provided with pressure switches 74, 76, 78 for supplying diagnostic signals to control unit 66 on lines 80 based on the respective relay valve positions. The control unit 66, in turn, monitors the various diagnostic signals for the purpose of electrically verifying proper operation of the controlled elements.

The solenoid-operated fluid control valves 58-64 are generally characterized as being either of the on/off or modulated type. To reduce cost, the electro-hydraulic control system 44 is configured to minimize the number of modulated fluid control valves, as modulated valves are generally more expensive to implement. To this end, fluid control valves 60 are a set of three on/off relay valves, shown in FIG. 1 as a consolidated block, and are utilized in concert with manual valve 56 to enable controlled engagement and disengagement of each of the clutches C1-C5. Valves 62, 64 are of the modulated type. For any selected ratio, the control unit 66 activates a particular combination of relay valves 60 for coupling one of the modulated valves 62, 64 to the on-coming clutch, and the other one of the modulated valves 62, 64 to the off-going clutch.

The modulated valves 62, 64 each comprise a conventional pressure regulator valve biased by a variable pilot pressure that is developed by current controlled force motors (not shown). Fluid control valve 58 is also a modulated valve, and controls the fluid supply path to converter clutch 19 in lines 70, 72 for selectively engaging and disengaging the converter clutch 19. The transmission control unit 66 determines pressure commands for smoothly engaging the on-coming clutch while smoothly disengaging the off-going clutch to shift from one speed ratio to another, develops corresponding force motor current commands, and then supplies current to the respective force motors in accordance with the current commands. Thus, the clutches C1-C5 are responsive to the pressure commands via the valves 58-64 and their respective actuating elements (e.g., solenoids, current-controlled force motors).

As indicated above, each shift from one speed ratio to another includes a fill or preparation phase during which an apply chamber 91 of the on-coming clutch is filled in preparation for torque transmission. Fluid supplied to the apply chamber compresses an internal return spring (not shown), thereby stroking a piston (not shown). Once the apply chamber is filled, the piston applies a force to the clutch plates, developing torque capacity beyond the initial return spring pressure. Thereafter, the clutch transmits torque in relation to the clutch pressure, and the shift can be completed using various control strategies. The usual control strategy involves commanding a maximum on-coming clutch pressure for an empirically determined fill time, and then proceeding with the subsequent phases of the shift. The volume of fluid required to fill an apply chamber and thereby cause the clutch to gain torque capacity is referred to as the “clutch volume.”

The controller 66 determines the timing of the pressure commands based on an estimated on-coming clutch volume, i.e., an estimated volume of fluid required to fill the on-coming clutch apply chamber and thereby cause the on-coming clutch to gain torque capacity. An estimated on-coming clutch volume must be used because the actual on-coming clutch volume may vary over time as a result of wear, and may vary from transmission to transmission because of build variations and tolerances.

The controller 66 calculates an estimated volume of fluid supplied to the on-coming clutch apply chamber as the chamber is being filled based on a mathematical model of the transmission hydraulic system, and compares the estimated volume of fluid supplied to the estimated clutch volume. When the estimated volume of fluid supplied to the apply chamber equals the estimated clutch volume, then the on-coming clutch should gain capacity. A hydraulic flow model for use in estimating the volume of fluid supplied to an apply chamber is described in U.S. Pat. No. 6,285,942, issued Sep. 4, 2001 to Steinmetz et al, which is hereby incorporated by reference in its entirety. The model inputs include the fill pressure, the shift type ST (for example, a 2-1 downshift), the speed of pump 46, and the temperature Tsump of the hydraulic fluid. The output of the model is the on-coming clutch flow rate. The flow rate is integrated by an integrator to form the estimated cumulative volume of fluid supplied to the apply chamber. In a preferred embodiment, the controller 66 subtracts the estimated volume of fluid supplied from the estimated clutch volume to determine an estimated clutch volume remaining. If the controller is accurate, the estimated clutch volume remaining will be zero at the time the on-coming clutch gains torque capacity.

Alternatively, instead of modulated valves 62, 64 and relay valves 60, the transmission may include a plurality of individual control valves each operatively connected to a respective apply chamber 91. Referring to FIG. 1A, an exemplary fluid control valve 90 includes a regulator 92, a solenoid 94 and a pressure sensor 96. Each control valve 90 is configured to provide fluid to the apply chamber 91 of its respective clutch C1-C5 at either a full feed state or a regulating state.

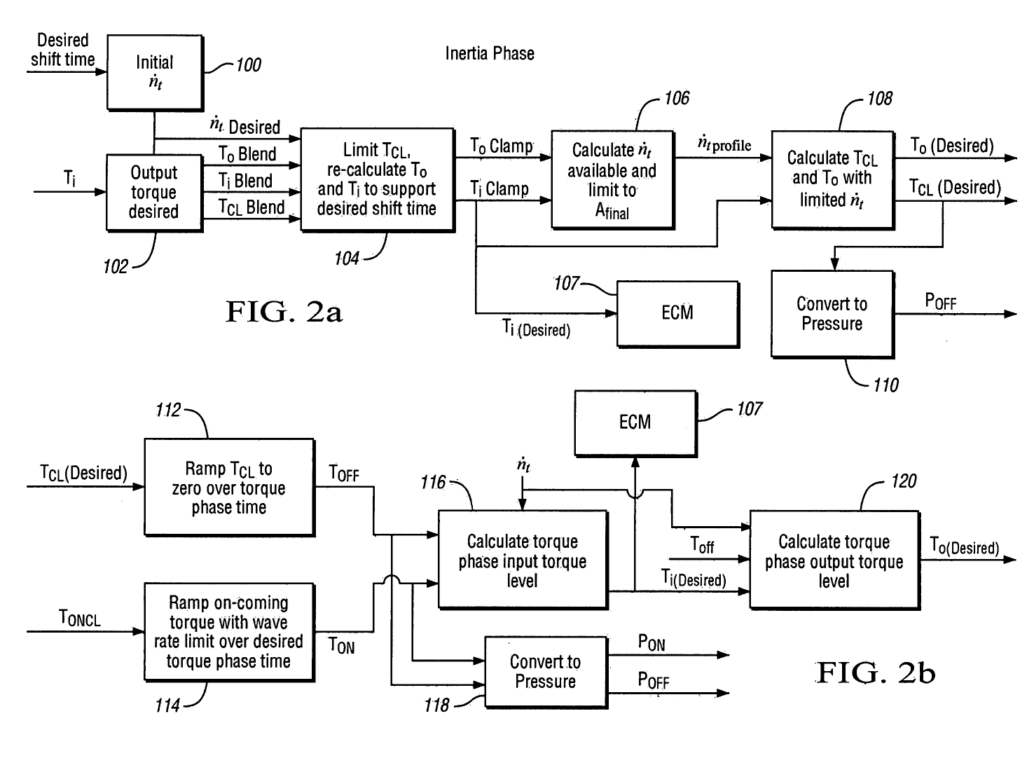

As shown in FIG. 2a, a method of the present invention calculates an optimal off-going clutch pressure during the inertia phase of a power-on downshift. The method shown in FIG. 2a and described hereinafter is predicated on the assumption that the output acceleration to output torque ratio does not change during the ratio change. Additionally, for purposes of this disclosure the derivative of a reference character is represented by the reference character with a dot thereabove as is well known in the field of mathematics. For example, the reference character nₜ represents turbine speed and the reference character \dot{n}ₜ represents the first derivative of turbine speed which is also known as turbine acceleration.

At step 100, the desired shift time is applied to establish a desired turbine acceleration profile as will be described in detail hereinafter. At step 102, the desired turbine acceleration \dot{n}ₜ and the current transmission input torque Ti are used to calculate the corresponding desired output torque To_Blend, and the output torque is modified by a scalar to the value of the desired output torque. The scalar is a calibration allowing for different combinations of clutch torque and input torque during the inertia phase such that shift time is maintained. In other words the scalar may be calibrated to provide either a firm shift or a more gentle shift during the same shift time. After output torque has been modified, a corresponding clutch torque Tcl_Blend is calculated. At step 104, clutch torque is limited and this limited torque value is used to recalculate input torque Ti_Clamp and output torque To_Clamp such that shift time is maintained. Also at step 104, the recalculated input torque Ti_Clamp is adjusted by a multiplication factor representative of the torque converter and sent to the engine control module 107. At step 106, available turbine acceleration is calculated and limited to a final turbine acceleration value A_{final} described hereinafter. At step 108, clutch torque and output torque are calculated with the limited turbine acceleration value established in step 106. At step 110 clutch torque is converted to a pressure value.

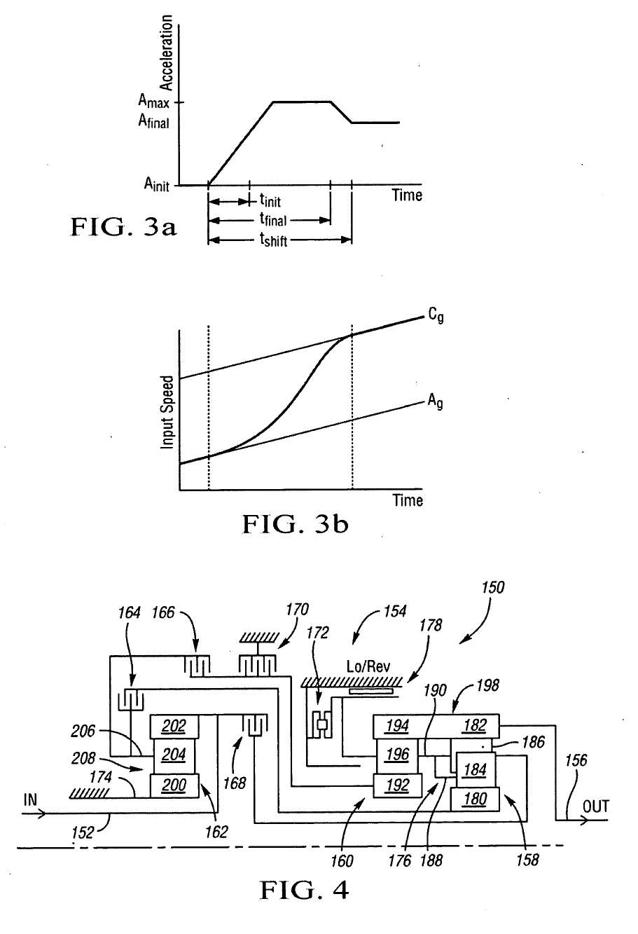

The turbine acceleration profile established at step 100 is shown in FIG. 3. More precisely, FIG. 3a depicts a desired input acceleration trajectory for the inertia phase of a power-on downshift from an attained gear speed Ag to a commanded gear speed Cg, assuming a constant output acceleration during the shift, and FIG. 3b depicts a corresponding input speed profile. As seen in FIG. 3b, the input speed prior to the inertia phase is determined by the product (output speed)×Ag, whereas the input speed at the conclusion of the inertia phase is determined by the product (output speed)×Cg.

The parameters of the acceleration trajectory of Graph A include the initial acceleration Aᵢₙᵢₜ, the maximum acceleration Aₘₐₓ, the final acceleration A_{final}, and the times tᵢₙᵢₜ, t_{final}, and t_{shift}. The terms A_{final}, tᵢₙᵢₜ, t_{final}, and t_{shift} are determined by calibration as a function of one or more other parameters. For example, t_{shift} may be determined as a function of driver torque demand, whereas tᵢₙᵢₜ and t_{final} may be predetermined percentages of t_{shift}. The value of A_{final} is a calibrated value selected to achieve smooth shift completion. Aᵢₙᵢₜ is the turbine speed measured prior to a shift event. Aₘₐₓ is computed based on the acceleration trajectory parameters and speed difference across the on-coming clutch, referred to herein as the slip speed.

The calculations performed in step 102 of FIG. 2a start with the following two basic equations:
\dot{n}ₜ=aₜTᵢ+bₜT_{cl}+cₜTₒ
\dot{n}ₒ=aₒTᵢ+bₒT_{cl}+cₒTₒ

The calibration constants aₜ, bₜ, cₜ, aₒ, bₒ, and cₒ are derived by summing the forces about the components of a particular transmission. As an example, FIG. 4 shows a free body diagram of an arbitrary transmission for which the calibration constants will be derived.

FIG. 4 schematically illustrates a six-speed planetary transmission 150. The transmission 150 includes an input shaft 152 connected directly with an engine (not shown), a multi-speed planetary gear arrangement 154, and an output shaft 156 connected directly with final drive mechanism (not shown). Planetary gear arrangement 154 includes a compound planetary gearset 158, two simple planetary gearsets 160 and 162, three selectively engageable rotating torque transmitting mechanisms 164, 166 and 168 and a selectively engageable stationary torque transmitting mechanism 170. In a preferred embodiment, the planetary gear arrangement 154 includes a 1-2 overrunning clutch “OWC” 172 installed between stationary housing 174 and common carrier assembly 176, and a modified low/reverse starting clutch 178.

The first planetary gearset 158 is shown to include a sun gear 180, a ring gear 182, and a planet carrier assembly 176. Meshed pairs of pinion gears 184 and 186 are rotatably supported on pinion shafts 188 and 190, respectively, that extend between laterally-spaced carrier segments of carrier assembly 176. Pinion gears 184 mesh with sun gear 180 while pinion gears 186 mesh with ring gear 182.

The second planetary gearset 160 includes a sun gear 192, a ring gear 194, and a plurality of pinion gears 196 that are meshed with both sun gear 192 and ring gear 194. As seen, pinion gears 196 are rotatably supported on pinion shafts 188 that also extend between the laterally-spaced carrier segments of carrier assembly 176. Thus, carrier assembly 176 is common to both first planetary gearset 158 and second planetary gearset 160. A ring gear assembly 198 is defined by ring gear 182 of first gearset 158 and ring gear 194 of second planetary gearset 160 being connected together to rotate as a unitary component. Third planetary gearset 168 is shown to include a sun gear 200, a ring gear 202, and pinion gears 204 in meshed engagement with both sun gear 200 and ring gear 202. Pinion gears 204 are rotatably supported on shafts 206 extending between components of a carrier assembly 208. In addition, sun gear 200 is shown to be held stationary due to its direct connection to a stationary housing portion 174 of transmission 150.

The calibration constants aₜ, bₜ, cₜ, aₒ, bₒ, and cₒ can be solved for the transmission of FIG. 4 using Newton's second law for rotational dynamics and summing the forces at the input and output of each component. The equations derived in this manner from the transmission of FIG. 4 are as follows:

$${I}_{202} * {\dot{ω}}_{202} = - {T}_{202} + ( {T}_{i} + {T}_{168} )$$

$${I}_{200} * {\dot{ω}}_{200} = {T}_{200} - {T}_{ground}$$

$${I}_{208} * {\dot{ω}}_{208} = {T}_{202} - {T}_{200} - {T}_{164} - {T}_{166}$$

$${I}_{204} * {\dot{ω}}_{204} = \frac{{T}_{202}}{{N}_{202}} ( \frac{{N}_{202} - {N}_{200}}{2} ) + \frac{{T}_{200}}{{N}_{200}} ( \frac{{N}_{202} - {N}_{200}}{2} )$$

$${N}_{200} * {\dot{ω}}_{200} = {\dot{ω}}_{208} ( \frac{{N}_{202} + {N}_{200}}{2} ) - {\dot{ω}}_{204} ( \frac{{N}_{202} - {N}_{200}}{2} )$$

$${N}_{202} * {\dot{ω}}_{202} = {\dot{ω}}_{208} ( \frac{{N}_{202} + {S}_{200}}{2} ) + {\dot{ω}}_{204} ( \frac{{N}_{202} - {N}_{200}}{2} )$$

$${I}_{180} * {\dot{ω}}_{180} = - {T}_{180} + {T}_{164}$$

$${I}_{176} * {\dot{ω}}_{176} = {T}_{180} - {T}_{182} - {T}_{192} - {T}_{178} - {T}_{172} + {T}_{168}$$

$${I}_{180} * {\dot{ω}}_{180} = - {T}_{180} + {T}_{164}$$

$${I}_{192} * {\dot{ω}}_{192} = {T}_{192} + {T}_{166} - {T}_{170}$$

$${I}_{182} * {\dot{ω}}_{182} = {T}_{182} - {T}_{156}$$

$${I}_{184} * {\dot{ω}}_{184} = {N}_{184} {F}_{184} - {T}_{180} ( \frac{{N}_{184}}{{N}_{180}} )$$

$$\begin{matrix}{I}_{196} * {\dot{ω}}_{196} = - \frac{{T}_{182}}{{N}_{182}} ( \frac{{N}_{182} - {N}_{192}}{2} ) + \frac{{T}_{192}}{{N}_{192}} ( \frac{{N}_{182} - {N}_{192}}{2} ) + \\ {F}_{184} ( \frac{{N}_{182} - {N}_{190}}{2} )\end{matrix}$$

$${N}_{192} * {\dot{ω}}_{192} = {\dot{ω}}_{176} ( {N}_{182} + {N}_{192} ) - {\dot{ω}}_{182} {N}_{182}$$

$${N}_{182} * {\dot{ω}}_{182} = {N}_{180} * {\dot{ω}}_{180} + {\dot{ω}}_{a1} ( {N}_{182} - {N}_{180} )$$

$${N}_{182} * {\dot{ω}}_{182} = {\dot{ω}}_{196} ( \frac{{N}_{182} - {N}_{192}}{2} ) + {N}_{182} * {\dot{ω}}_{176}$$

$${N}_{184} * {\dot{ω}}_{184} = {\dot{ω}}_{186} ( \frac{{N}_{182} - {N}_{192}}{2} )$$

$${\dot{ω}}_{208} = {\dot{ω}}_{180}$$

where T is a torque value, I is inertia, F is force, ω is rotational velocity, \dot{ω} is rotational acceleration and N is the number of teeth on a particular gear element. \dot{n} and \dot{ω} are both rotational acceleration values but are differentiated in that \dot{n} is measured in rpm/second² whereas \dot{ω} is measured in radians/second².

Having solved for the calibration constants associated with a particular transmission, corresponding values for \dot{n}ₜ and \dot{n}ₒ are calculated from the two basic equations provided hereinabove. At step 102 of FIG. 2a, the values of \dot{n}ₜ and \dot{n}ₒ are then input into the following equation to solve for Tₒ_{_{—}}Blend.

$${T}_{o} \_Blend = \frac{{\dot{n}}_{t} - ( {a}_{t} - {b}_{t} {a}_{o} / {b}_{o} ) {T}_{i}}{( {b}_{t} / {b}_{o} ( {\dot{n}}_{o} / {T}_{o} ) i - {b}_{t} {c}_{o} / {b}_{o} + {c}_{t} )}$$

It should be appreciated that assumption made for the torque phase of the ratio change described hereinabove, specifically that the output acceleration to output torque ratio does not change during the ratio change, is embodied by the term (\dot{n}ₒ/Tₒ) i. Therefore this term becomes a constant measured only at the beginning of the ratio change.

As the value of \dot{n} derived from the free body diagram of the transmission was based on the desired shift time, the corresponding value of To_Blend is similarly scaled to meet the desired shift time.

At step 102 of FIG. 2a, the value of To_Blend scaled to meet desired shift time is then input into the following equation to solve for Tcl_Blend, which is thereby also scaled to follow both the desired shift time and the scaled output torque.

$${T}_{cl} \_Blend = \frac{\{ [ {( {\dot{n}}_{o} / {T}_{o} )}_{i} + {a}_{o} {c}_{t} / {a}_{t} - {c}_{o} ] {T}_{o} - {a}_{o} / {a}_{t} * {\dot{n}}_{t} \}}{( {b}_{o} - {a}_{o} {b}_{t} / {a}_{t} )}$$

At step 104 of FIG. 2a, a limited value of output torque To_Clamp is recalculated with the limited value of clutch torque Tcl according to the equation:

$${T}_{o} \_Clamp = \frac{[ {T}_{cl} ( {b}_{o} - {a}_{o} {b}_{t} / {a}_{t} ) + {a}_{o} / {a}_{t} * {\dot{n}}_{t} ]}{[ {( {\dot{n}}_{o} / {T}_{o} )}_{i} + {a}_{o} {c}_{t} / {a}_{t} - {c}_{o} ]}$$

The recalculated value of output torque Tₒ_{_{—}}Clamp and the limited value of clutch torque T_{cl}_{_{—}}Blend are input into the following equation to derive a base input torque Tᵢ_{_{—}}Clamp required to achieve the desired shift time.

$${T}_{i} \_Clamp = \frac{{\dot{n}}_{t} - {b}_{t} {T}_{cl} + {c}_{t} {T}_{o}}{{a}_{t}}$$

This value of input torque is limited to levels that the engine can produce, which thereby may necessitate modification of the desired shift time.

At step 106 of FIG. 2a, the limited input torque Tᵢ_{_{—}}Clamp and, if necessary, the modified desired shift time are input into the following equation to generate an attainable turbine acceleration \dot{n}ₜ.
\dot{n}ₜ={aₜ+cₜaₒ/[(\dot{n}ₒ/Tₒ)ᵢ−cₒ]}*Tᵢ+{bₜ+cₜbₒ/[(\dot{n}ₒ/Tₒ)ᵢ−cₒ]}*T_{cl}

At step 108 of FIG. 2a, values for clutch torque and output torque required to meet constraints identified hereinabove are respectively calculated according to the following equations:

$${T}_{cl} = \frac{[ {( {\dot{n}}_{o} / {T}_{o} )}_{i} - {c}_{o} ] {\dot{n}}_{t} - {a}_{t} {T}_{i} [ {( {\dot{n}}_{o} / {T}_{o} )}_{i} - {c}_{o} ] - {c}_{t} {a}_{o} {T}_{i}}{\{ [ {( {\dot{n}}_{o} / {T}_{o} )}_{i} - {c}_{o} ] {b}_{t} + {c}_{t} {b}_{o} \}}$$

$${T}_{o} = \frac{[ {T}_{cl} ( {b}_{o} - {a}_{o} {b}_{t} / {a}_{t} ) + {a}_{o} / {a}_{t} * {\dot{n}}_{t} ]}{[ {( {\dot{n}}_{o} / {T}_{o} )}_{i} + {a}_{o} {c}_{t} / {a}_{t} - {c}_{o} ]} .$$

At step 110, the torque value for the off-going clutch T_{cl} is converted to a pressure value P_{off}.

FIG. 2b illustrates a method for calculating an optimal value for transmission input torque during the torque phase of the ratio change. Engine output may then be altered by an amount necessary to change the actual value of the transmission input torque to the calculated optimal value of transmission input torque. FIG. 2b is distinguishable from FIG. 2a in part because FIG. 2a is implemented during the inertia phase and FIG. 2b is implemented during the torque phase of a shift event.

At step 112 of FIG. 2b, the off-going clutch torque T_{cl} calculated according to the method of FIG. 2a is ramped to zero over the duration of the torque phase time to produce a ramped off-going clutch torque T_{off}. At step 114, which is performed generally simultaneously with step 112, on-coming clutch torque T_{oncl} is ramped from a calibration threshold to a value representing the holding torque for the next gear ratio over the duration of the torque phase time. The ramped on-coming clutch torque derived at step 114 is identified by reference character Tₒₙ. At step 116, the torque phase input torque Tᵢ is calculated. Also at step 116, the recalculated input torque Ti (Desired) is adjusted by a multiplication factor representative of the torque converter and sent to the engine control module 107. At step 118, the torque values for the on-coming and off-going clutch Tₒₙ and T_{off} are converted to corresponding pressure values Pₒₙ and P_{off}. In an alternate embodiment, at step 118 the torque value off-going clutch T_{off} is converted to corresponding pressure value P_{off}, and the pressure value used for Pₒₙ is that which is achieved by filling the on-coming clutch at the maximum fill rate. At step 120, the torque phase output torque Tₒ is calculated.

At step 116 of FIG. 2b, the following two equations are used to calculate the torque phase input torque Tᵢ:
Tₒₙ=k₆₁Tₒ+k₆₂Tᵢ+k₆₃\dot{n}ₜ
T_{off}=k₆₄Tₒ+k₆₅Tᵢ+k₆₆\dot{n}ₜ

The values k₆₁, k₆₂, k₆₃, k₆₄, k₆₅ and k₆₆ are calibration constants which are solved for a particular transmission in a manner similar to that described hereinabove for the calibration constants aₜ, bₜ, cₜ, aₒ, bₒ, and cₒ. Input torque is then solved for using the equation:

$${T}_{i} = \frac{- ( {k}_{61} / {k}_{64} * {T}_{off} - {T}_{on} - {k}_{66} {k}_{61} / {k}_{64} * {\dot{n}}_{t} + {k}_{63} * {\dot{n}}_{t} )}{( - {k}_{61} {k}_{65} / {k}_{64} + {k}_{62} )}$$

The value of input torque derived from this equation represents the amount of engine torque necessary at synchronization. In a preferred embodiment, a reduction of engine torque is accomplished by spark arrest and an increase of engine torque is accomplished by opening the throttle. It should be appreciated, however, that there are numerous methods for increasing and/or decreasing engine torque.

The method of the present invention establishes two adaptive parameters for each power-on downshift. The adaptive parameters include an off-going clutch pressure adaptive parameter, and an on-coming clutch volume adaptive parameter. The adaptive parameters are so named because they are monitored and may be adapted to improve subsequent downshifts.

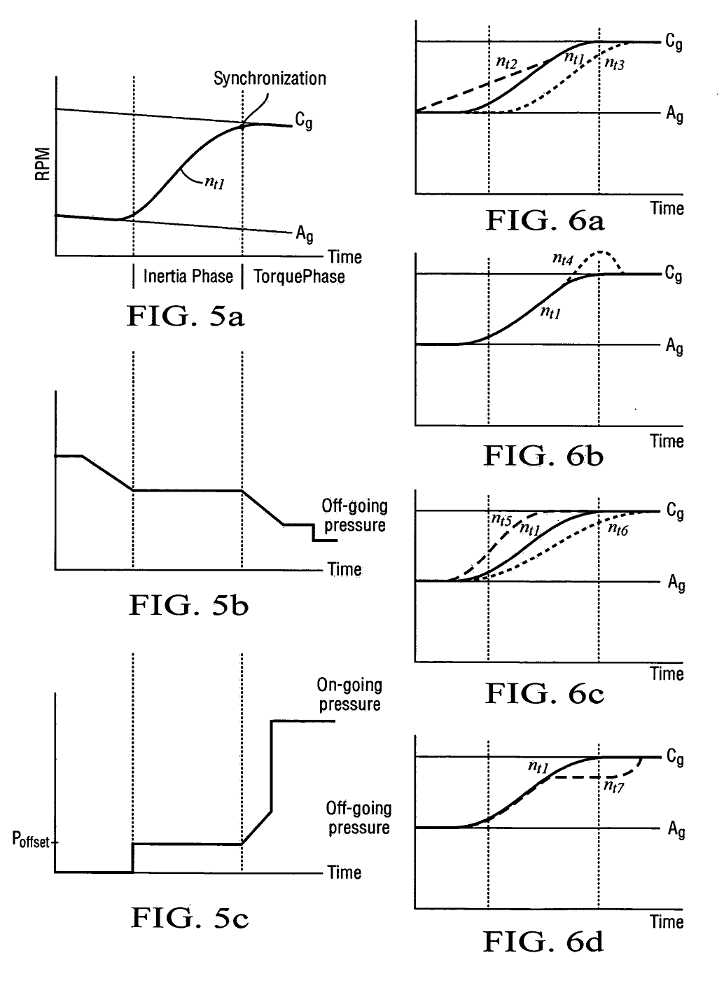

FIGS. 5a-5c show a predefined optimal power-on downshift. More precisely, FIG. 5a shows an optimal torque converter turbine speed nₜ₁ transitioning from the attained gear speed Ag to the commanded gear speed Cg. Those skilled in the art will recognize that the turbine and input shaft are interconnected, and, accordingly, the turbine speed is the same as the input shaft speed. Those skilled in the art will also recognize that the attained gear speed Ag is the transmission output speed multiplied by the currently selected gear ratio, whereas the commanded gear speed Cg is the transmission output speed multiplied by the commanded gear ratio. Accordingly, during a power-on 4-3 downshift, Ag is transmission output speed multiplied by the fourth gear ratio and Cg is the transmission output speed multiplied by the third gear ratio.

FIG. 5c shows on-coming clutch pressure during the power-on downshift, including the fill phase in which the on-coming clutch apply chamber is filled and wherein on-coming torque is zero. Similarly, FIG. 5b shows off-going clutch pressure during the power-on downshift. During an optimal power-on downshift, there is zero on-coming clutch torque until turbine speed Ts reaches the point of synchronization identified in FIG. 5a. It should also be appreciated that the point of synchronization also represents the beginning of the torque phase.

Torque applied by the off-going clutch is preferably converted from off-going clutch pressure according to a table. The table provides a torque versus pressure curve defined by multiple points or cells. In a preferred embodiment, the table is a three-place table defined by three cells. This provides flexibility by allowing adaptive correction of the torque to pressure relationship at a specific point on the curve without altering the remainder of the curve. In other words, only the cells attributable to a particular aberration are updated.

As seen in FIG. 5c, at the point of synchronization on-coming clutch pressure is equal to the pressure applied by the on-coming clutch return spring (not shown) and zero torque is therefore being applied by the on-coming clutch. Immediately after the point of synchronization, the on-coming clutch is generating some torque but not enough to prevent a past-synchronization condition, hereinafter called engine flare, wherein the turbine speed nₜ exceeds the commanded gear speed Cg. The method of the present invention therefore implements engine torque management at the point of synchronization to prevent engine flare.

The shift aberrations, i.e., deviations, from the predefined optimal shift of FIG. 5a that are correctable by adjusting the off-going pressure adaptive parameter are graphically represented in FIGS. 6a-c. In FIG. 6a, turbine speed nₜ₂ represents the shift aberrations “slip early” and turbine speed nₜ₃ represents the shift aberration “slip late.” Slip early and slip late are both potentially attributable to inadequate off-going clutch pressure.

Deviation of turbine speed Tₛ from attained gear speed A_{g} is monitored by the control unit to determine the occurrence of slip early or slip late. If turbine speed nₜ prematurely rises more than a predetermined amount, e.g., 50 rpm, above attained gear speed A_{g}, slip early is indicated. Conversely, if turbine speed nₜ is delayed in rising more than a predetermined amount, e.g., 50 rpm, above attained gear speed A_{g}, slip late is indicated.

As shown in FIG. 6b, flare is a shift aberration wherein the turbine speed nₜ₄ rises more than a predetermined amount, e.g., 50 rpm, above commanded gear speed C_{g}.

The turbine speed during a short shift and a long shift are graphically depicted by line nₜ₅ and line nₜ₆ of FIG. 6c, respectively, and are contrasted by the solid line representation of turbine speed nₜ₁ during the predefined optimal power-on downshift. A short shift or long shift is identified by comparing the duration of the inertia phase with a predetermined optimal shift time. The duration of the inertia phase is the period of time beginning when the turbine speed is a predetermined amount, e.g., 50 rpm, greater than the attained gear speed Ag and ending when the turbine speed is a predetermined amount, e.g., 50 rpm, less than the commanded gear speed Cg. Insufficient inertia phase duration, i.e., in comparison to the predetermined optimal shift time, is indicative of a short shift, and excessive inertia phase duration is indicative of a long shift.

The controller is configured for closed-loop control of commanded pressure. Accordingly, the controller is configured to recognize deviation between intended pressure and actual pressure based on deviation between actual turbine speed and intended turbine speed. Previously addressed shift aberrations are detected by the controller comparing the actual characteristics of a shift to a predefined optimal shift. The controller is further configured to analyze information obtained from the closed loop control to adjust the off-going pressure adaptive parameter accordingly.

The turbine speed during a closed loop increase and a closed loop decrease is graphically similar to a short shift and long shift, respectively. Therefore, referring to FIG. 6c, the turbine speed during a closed loop increase is graphically depicted by line nₜ₅, and the turbine speed during a closed loop decrease is graphically depicted by line nₜ₆. As error between actual turbine speed profile and intended turbine speed profile increases, the closed loop control causes the commanded pressure to proportionally increase to correct the error. A “closed loop increase” or a “closed loop decrease” occurs when the commanded pressure increases or decreases by more than a predetermined maximum threshold.

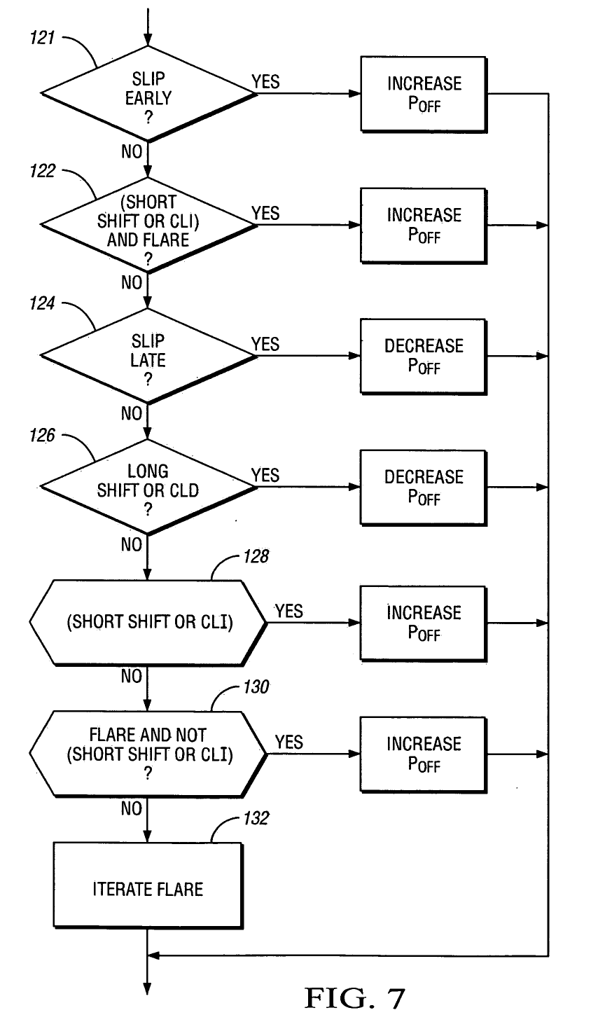

A method for addressing the shift aberrations identified hereinabove by adjusting the off-going pressure adaptive parameter is shown in FIG. 7. At step 121, if slip early is detected the off-going pressure adaptive parameter is increased. At step 122, if either a short shift or a closed loop increase is detected and flare is detected, the off-going pressure adaptive parameter is increased. According to a preferred embodiment of the present invention, the off-going adaptive parameter is the multi-place table described hereinabove and the cells are increased at steps 121 and 122 in proportion to their degree of responsibility for a particular aberration. At step 124, if slip late is detected the off-going pressure adaptive parameter is decreased. At step 126, if either a long shift or a closed loop decrease is detected the off-going pressure adaptive parameter is decreased. At step 128, if either a short shift or a closed loop increase is detected and the criteria for steps 120-126 are not met, the off-going pressure adaptive parameter is decreased. At step 130, if flare is detected and there is not a short shift or closed loop increase, the off-going pressure adaptive parameter is increased. At step 132, if the criteria for steps 120-130 are not met the off-going pressure adaptive parameter is incrementally decreased to produce flare as will be described in detail hereinafter.

To correct the adaptive parameter at step 132, the off-going pressure adaptive parameter is revised after a predetermined number of shifts during which the criteria for steps 120-130 are not met. More precisely, if a predetermined number of shifts occur without meeting the criteria for steps 120-130, the low torque cell point of the multi-place off-going pressure adaptive parameter is incrementally reduced during subsequent shifts until any increase aberration is detected or minimum clamp is achieved, and thereafter the low torque cell point is incrementally increased until the aberration no longer exists. In the preferred embodiment of the present invention, the off-going pressure adaptive parameter is composed of the three-place table described hereinabove and the correction at step 132 is applied only to the low torque cell, however it should be appreciated that in alternate embodiments such correction may be applied to additional cells.

The off-going pressure adaptive parameter is preferably increased or decreased according to the method of FIG. 7 by a corrective value obtained by the following equation: (full correction)(scalar)(gain)(gain2). Full correction is either a calibration or measured signal, such as from turbine speed, that gives a term to correct the adaptive problem. The scalar is a function of the shift aberration type, since some shift aberrations require more aggressive corrective action than others. The gain is related to an adaptive error counter that tracks the direction the off-going pressure adaptive parameter is moving. Gain2 is a variable adapted to assign a weighted correction to the specific cells in the off-going clutch multi-place adaptive that are attributable to a given aberration. Accordingly, Gain2 corrects the cells of the off-going clutch multi-place adaptive in proportion to their degree of responsibility for the aberration such that the correction is not necessarily evenly applied. If the off-going pressure adaptive parameter increases during consecutive downshifts, the adaptive error counter is increased by one each shift to a predetermined maximum value, e.g., seven. Similarly, if the off-going pressure adaptive parameter decreases during consecutive downshifts, the adaptive error counter is decreased by one each shift to a predetermined minimum value, e.g., negative seven. The gain is established based on the adaptive error counter value such that the magnitude of the gain is proportional to the absolute value of the adaptive error counter. In other words, each consecutive increase or decrease in the adaptive error counter gives rise to a larger gain. In this manner the degree of adaptive correction can be increased if the off-going pressure adaptive parameter has been commanded to change in one direction, i.e., increased or decreased, during consecutive downshifts. Thus, the corrective value varies in response to the quantity of consecutive monitored downshifts in which a shift aberration occurs. If the off-going pressure adaptive parameter is increased and then subsequently decreased, or vice versa, the adaptive error counter is reset to zero and the gain becomes its minimal value. Additionally, it should be appreciated that the volume adaptive parameters are increased and decreased in a similar manner.

Having described the off-going pressure corrections in detail hereinabove, the following will discuss the on-coming volume adaptive parameter. Referring to FIG. 6d, a shift aberration, i.e., deviation, from the predefined optimal shift of FIG. 5a that is correctable by adjusting the on-coming volume is shown. More precisely, FIG. 6d shows the aberration underlap turbine float which is a shift aberration wherein the turbine speed nₜ₇ floats at a value below the commanded gear speed Cg and thereby fails to reach the commanded gear speed Cg in the desired time.

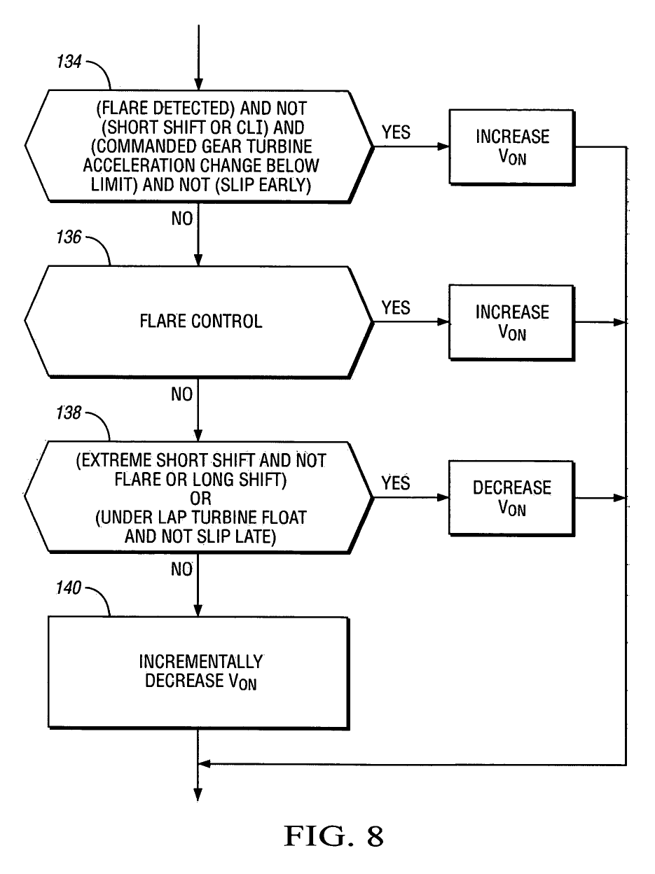

A method for adjusting the on-coming volume adaptive parameter is shown in FIG. 8. At step 134, the on-coming volume adaptive parameter is increased when flare is detected, neither short shift nor closed loop increase are detected, the commanded gear turbine acceleration is below a predefined minimum value, and slip early is not detected. At step 136, the on-coming volume adaptive parameter is increased when flare control is invoked. Flare control is invoked when Tₛ exceeds the commanded gear speed Cg by an amount deemed excessive. In a preferred embodiment of the present invention, flare control is invoked when Tₛ exceeds the commanded gear speed Cg by more than, for example, 300 rpm. At step 138, the on-coming volume adaptive parameter is decreased when there is an extreme short shift detected and neither flare nor long shift are detected, or when underlap turbine float is detected and slip late is not detected. At step 140, the on-coming volume adaptive parameter is incrementally decreased. The incremental decrease at step 132 is performed in the same manner as that described hereinabove for the off-going pressure adaptive parameter at step 122. Additionally, it should be appreciated that the incremental decrease of steps 132 and 122 are preferably configured to alternate during subsequent shifts such that only one or the other is performed during a single shift.

The aberrations flare and short shift may be attributable to either inadequate pressure or inadequate calculated volume. Therefore at step 134 there is an upper limit for the on-coming volume adaptive parameter intended to prevent on-coming volume correction of an aberration caused by an incorrect off-going pressure value. More precisely, an aberration that suggests an increase of the learned volume above the maximum limit is likely attributable to off-going pressure rather than volume, and the problem is addressed by the off-going pressure adaptive described hereinabove. The limit applied at step 134 is preferably implemented with a pressure switch (not shown) adapted to inhibit an increase in on-coming volume above a predefined maximum value. In this manner the off-going pressure and on-coming volume adaptives work together to identify which is responsible for the aberration and thereafter address the aberration in the appropriate manner.

While the best mode for carrying out the invention has been described in detail, those familiar with the art to which this invention relates will recognize various alternative designs and embodiments for practicing the invention within the scope of the appended claims.

1. A method for improving power-on downshifts of a powertrain having an automatic transmission and a power source, said automatic transmission further having an off-going clutch and an on-coming clutch, said method comprising:
calculating an optimal off-going clutch torque and pressure;
calculating an optimal transmission input torque value;
controlling output of said power source in a manner to change a current transmission input torque value to that of said optimal transmission input torque value;
establishing adaptive parameters;
monitoring transmission operating characteristics during a power-on downshift;
analyzing said transmission operating characteristics to identify at least one predefined aberration from a predefined optimal downshift; and
adjusting the adaptive parameter in response to said at least one aberration to improve subsequent power-on downshifts.

2. The method of claim 1, wherein said adaptive parameter is a multi-place off-going clutch pressure adaptive parameter composed of a plurality of cells.

3. The method of claim 2, wherein said adjusting the adaptive parameter includes adjusting the multi-place off-going clutch pressure adaptive parameter.

4. The method of claim 3, wherein adjusting the multi-place adaptive parameter includes adjusting one or more cells according to their respective degree of responsibility for a particular aberration whereby the cells adjustment is not necessarily evenly applied to the cells.

5. The method of claim 4, further comprising monitoring said transmission operating characteristics during a predetermined quantity of power-on downshifts subsequent to said first power-on downshift; and reducing the adaptive parameter after each of at least one downshift subsequent to the predetermined quantity of power-on downshifts until an increasing aberration occurs if said at least one aberration is not detected during the predetermined quantity of power-on downshifts.

6. The method of claim 1, wherein said on-coming clutch has an apply chamber and said adaptive parameter is the estimated volume of said on-coming clutch apply chamber.

7. The method of claim 1, wherein said calculating an optimal off-going clutch pressure during said torque phase of said power-on downshift is based on a torque analysis of said transmission.

8. The method of claim 1, wherein said calculating an optimal transmission input torque value during said inertia phase of said power-on downshift is based on a torque analysis of said transmission.

9. The method of claim 1, wherein said controlling said power source output by an amount necessary to change a current transmission input torque value to that of said optimal transmission input torque value is performed by arresting spark of said power source.

10. The method of claim 1, wherein said controlling said power source output by an amount necessary to change a current transmission input torque value to that of said optimal transmission input torque value is performed by altering fuel consumption of said power source.

11. The method of claim 1, wherein said controlling said power source output by an amount necessary to change a current transmission input torque value to that of said optimal transmission input torque value is performed by altering air intake of said power source.

12. A control apparatus for a powertrain having a power source and an automatic transmission, said automatic transmission having an input shaft and an output shaft; a first clutch and a second clutch; a first and second fill chamber to which hydraulic fluid is supplied for hydraulic actuation of the first and second clutch, respectively; a first and second actuator configured to selectively allow pressurized fluid into the first and second fill chamber, respectively; wherein the first clutch and the second clutch are configured to effect a speed ratio change during a power-on downshift by disengagement of the first clutch and engagement of the second clutch, the control apparatus comprising:
a controller operatively connected to the first actuator and the second actuator to control selective disengagement of the first clutch whereby the first clutch is an offgoing clutch, and engagement of the second clutch whereby the second clutch is an oncoming clutch;
wherein said controller is programmed and configured to calculate an optimal off-going clutch pressure;
wherein said controller is programmed and configured to calculate an optimal transmission input torque value;
wherein said controller is programmed and configured to control output of said power source in order to change a current transmission input torque value to that of said optimal transmission input torque value;
wherein said controller is programmed and configured to establish an adaptive parameter;
wherein said controller is programmed and configured to monitor transmission characteristics during said power-on downshifts;
wherein said controller is programmed and configured to analyze said transmission characteristics to identify predefined shift aberrations from a predefined optimal shift; and
wherein said controller is programmed and configured to adjust the adaptive parameter in response to said shift aberrations such that said shift aberrations are corrected and subsequent downshifts are improved.

13. The apparatus of claim 12, wherein said controller is programmed and configured to generate off-going clutch pressure commands to which the off-going clutch is responsive, and wherein the adaptive parameter is a three place table for off-going clutch pressure.

14. The apparatus of claim 12, wherein said controller is configured to generate oncoming clutch pressure commands to which the on-coming clutch is responsive; wherein the controller is configured to determine when to generate the oncoming clutch pressure commands to effect a speed ratio change based on an estimated oncoming clutch apply chamber volume; and wherein the adaptive parameter is an oncoming clutch volume adaptive parameter on which the value of the estimated oncoming clutch apply chamber volume is dependent.

15. The method of claim 12, wherein said controller is configured to control said power source output by altering fuel consumption.

16. A method comprising:
establishing an adaptive parameter;
calculating an initial estimated value for said adaptive parameter;
monitoring transmission operating characteristics during a plurality of power-on downshifts;
determining whether, for each of the plurality of downshifts, the transmission operating characteristics indicate the occurrence of a predefined shift aberration from a predefined optimal downshift; and
adjusting the value of the adaptive parameter after each of said downshifts for which the transmission operating characteristics indicate the occurrence of the first shift aberration.

17. The method of claim 16, wherein said adjusting the value of the adaptive parameter includes applying a corrective value to the adaptive parameter.

18. The method of claim 16, further comprising varying the corrective value in response to the quantity of consecutive monitored downshifts in which the first predetermined shift aberration occurs.
